(19) United States
(12) Patent Application Publication
(10) Pub. No.: US 2012/0018008 A1
(43) Pub. Date: Jan. 26, 2012

(54) Apparatus for supplying source

(75) Inventors: Dong Joo Shin, Gunpo-si (KR); Sung Taek Lim, Suwon-si (KR); Choon Keun Lee, Suwon-si (KR)

(73) Assignee: SAMSUNG ELECTRO-MECHANICS CO., LTD., Suwon (KR)

(21) Appl. No.: 12/926,823

(22) Filed: Dec. 10, 2010

(30) Foreign Application Priority Data
Jul. 26, 2010 (KR) 10-2010-0071932

(51) Int. Cl. F99Z 99/00

(52) U.S. Cl. 137/386

(57) ABSTRACT

Disclosed herein is an apparatus for supplying a source for constantly maintaining a film source water level in a source reservoir.

The apparatus for supplying a source according to the present invention includes a source reservoir into which a liquid-phase film source is injected; a carrier film that is horizontally delivered from one side of the source reservoir; a casting roller that is rotated along the delivery direction of the carrier film and applies the liquid-phase film source injected into the source reservoir to the carrier film; a water level control plate that is vertically driven in the source reservoir to control the liquid-phase film source level; and a plate driving unit that moves the water level control plate up and down.

### CROSS REFERENCE TO RELATED APPLICATION

This application claims the benefit under 35 U.S.C. Section [120, 119, 119(e)] of Korean Patent Application serial No. 10-2010-0071932, entitled “Apparatus For Supplying Source”, filed on Jul. 26, 2010, which is hereby incorporated by reference in its entirety into this application.

### BACKGROUND OF THE INVENTION

1. Technical Field

The present invention relates to an apparatus for supplying a source, and more particularly, to an apparatus for supplying a source capable of constantly controlling a water level of a film source by moving a water control plate included in a source reservoir during a casting process of manufacturing an insulating film.

2. Description of the Related Art

Recently, as digital electronic products have been miniaturized with multiple functions while using various state-of-the-art technologies, they mount various types of components and the number of components inserted into one product has gradually increased.

As a result, as a substrate on which a plurality of components are mounted should be thin and highly integrated in order to meet high specification of electronic products, a thin insulating film usable as an insulating layer included in the substrate has been used.

In this case, in order to manufacture the insulating film, a casting process for manufacturing the film at a desired thickness using an epoxy resin, etc., should be made. The casting process may use a slot die scheme, a comma coater scheme, a dam scheme, or the like, according to a head scheme of a useable device. Among others, the comma coater scheme using a roller has been mainly used to manufacture a thick film due to a simple injection and manipulation of a source.

The comma coater scheme manufactures the film having the desired thickness by loading the liquid-phase epoxy resin injected into the source reservoir onto a carrier film through the roller. In this case, since the manufactured film has high content of solvents, it passes to a drying end in which the film loaded at a temperature of 45° C. to 80° C. is dried.

Thereafter, the film dried through the drying end is covered with a cover film to protect the surface and after the cover film is removed in a post-process, the process is performed.

As main factors to determine the thickness of the insulating film during the process of manufacturing the insulating film, there are the viscosity of the film source having a liquid-phase resin type and the driving speed of the casting roller. However, when the liquid-phase source injected into the source reservoir is not maintained at a predetermined water level, the amount of film applied through the casting roller is not constant, thereby causing deviation in the thickness of the film and defects on the surface thereof.

In order to prevent this, the related art has mainly used a scheme for a worker to manually inject the film source using a scraper, etc., when the amount of source loadable through the casting roller is small due to the consumption of the source in the source reservoir; however, when the source does not maintain a predetermined water level since the source is consumed up to a water level lower than the diameter of the casting roller due to the increased consumption of the source, the amount of source loadable through the casting roller is not constant, thereby causing deviation in the thickness of the film.

Further, since the film source positioned at the corners in the source reservoir is not circulated but continuously remains at the corner, it cannot but be discarded when the source is replaced, thereby causing a loss of the source. As a result, when the source of the film is expensive, the increase in the loss is inevitable.

### SUMMARY OF THE INVENTION

An object of the present invention is to provide an apparatus for supplying a source capable of automatically injecting a film source according to a water level of a liquid-phase film source while constantly maintaining the water level of the film source by automatically moving a water level by controlling the plate up and down in order to control the water level of a liquid-phase film source injected into a source reservoir during a casting process for manufacturing an insulating film.

According to an exemplary embodiment of the present invention, there is provided an apparatus for supplying a source, including: a source reservoir into which a liquid-phase film source is injected; a carrier film that is horizontally delivered from one side of the source reservoir; a casting roller that is rotated along the delivery direction of the carrier film and applies the liquid-phase film source injected into the source reservoir to the carrier film; a water level control plate that is vertically driven in the source reservoir to control the liquid-phase film source level; and a plate driving unit that moves the level control plate up and down.

The apparatus for supplying a source further includes a sensor that senses the amount of liquid-phase film source injected into the source reservoir; and a controller that moves the water level control plate with respect to the amount of the film source sensed in the sensor to constantly control the film source water level in the source reservoir.

The apparatus for supplying a source further includes: a source supplying unit that receives information on the consumed amount of film source from the sensor sensing the consumed amount of liquid-phase film source injected into the source reservoir to automatically supply the liquid-phase film source to the source reservoir; and a pumping unit that supplies the liquid-phase film source into the source reservoir from the source supplying unit.

The casting roller is driven to be rotated at a position fixed to the upper portion of the source reservoir and the outer peripheral surface thereof is provided with a step at an equidistance to apply a liquid-phase film source injected into the source reservoir through the step to the carrier film delivered from one side of the source reservoir.

In this case, the sensor that is a unit for controlling the film source received in the source reservoir to the predetermined water level senses the mass of the film source to control the water level or senses the height where the upper portion of the film source is positioned within the source reservoir to control the water level.

The water level of the film source received in the source reservoir is controlled by the water level control plate and the water level of the film source is constantly controlled at all times by elastically moving the water level control plate within the source reservoir. In this case, the water level control plate moves up and down within the source reservoir by the plate driving unit including the elastic part.

The plate driving unit may include an elastic part attached to the bottom surface of the source reservoir and a driving assembly transferring a driving force to the water level control plate.

The plate driving unit may be installed at both side portions or a central portion of the water level control plate as a plurality of members or a single member and the up, down, left, and right angles of the plate driving unit may be controlled by a driving force of the plate driving unit.

### BRIEF DESCRIPTION OF THE DRAWINGS

FIG. 1 is a perspective view of an apparatus for supplying a source according to the present invention;

FIG. 2 is a cross sectional view of an apparatus for supplying a source according to the present invention before a water level of a source is controlled;

FIG. 3 is a cross sectional view of an apparatus for supplying a source according to the present invention after a water level of a source is controlled; and

FIG. 4 is a diagram showing a configuration of an apparatus for supplying a source according to the present invention.

### DESCRIPTION OF THE PREFERRED EMBODIMENTS

The acting effects and technical configuration with respect to the objects of a lead pin for a package substrate according to the present invention will be clearly understood by the following description in which exemplary embodiments of the present invention are described with reference to the accompanying drawings.

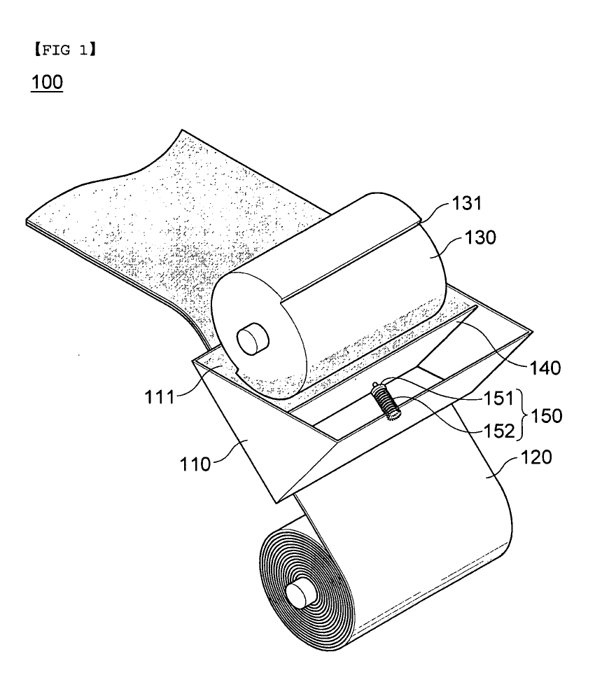

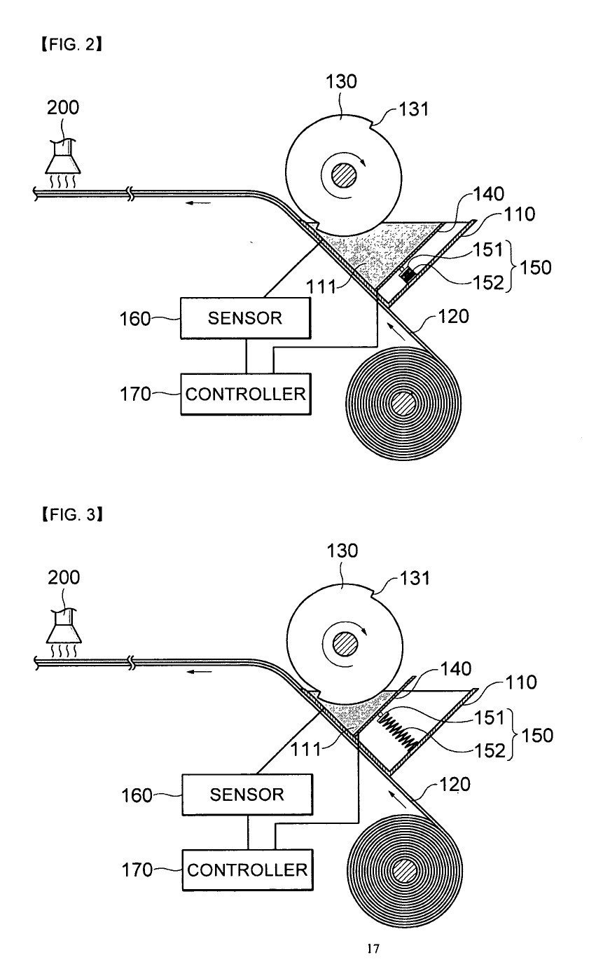

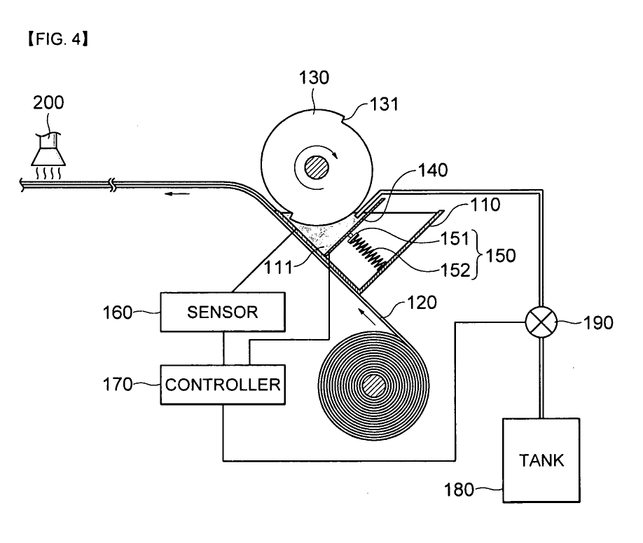

FIG. 1 is a perspective view of an apparatus for supplying a source according to the present invention, FIG. 2 is a cross sectional view of an apparatus for supplying a source according to the present invention before a water level of a source is controlled, and FIG. 3 is a cross sectional view of an apparatus for supplying a source according to the present invention after a water level of a source is controlled.

As shown in FIG. 1, an apparatus 100 for supplying a source according to the exemplary embodiment of the present invention may be configured to include a source reservoir 110 into which a liquid-phase film source 111 is injected, a casting roller 130 applying the film source 111 on a carrier film 120 delivered to one side thereof while being rotated in one direction within the source reservoir 110, and a water level control plate 140 moving in order to control the water level of the film source 111 within the source reservoir 110.

Further, the apparatus for supplying a source according to the exemplary embodiment may further include a drying unit 200 that dries the film source 111 during the delivery period of the carrier film 120 to adhere it to the carrier film 120 when the liquid-phase film source 111 is delivered, while being applied to the carrier film 120, by the rotation of the casting roller 130.

The source reservoir 110 may be formed in an enclosed type and the casting roller 130 fixed at any point of the upper portion of the source reservoir 110 applies the liquid-phase film source 111 to the carrier film 120 delivered from one side of the source reservoir 110 while it is rotated.

Further, the casting roller 130 includes a scraper 131 at both side portions of an outer peripheral surface and the film source 111 in the source reservoir 110 may be easily applied to the carrier film 120 by the scraper 131.

In this case, the liquid-phase film source 111 in the source reservoir 110 may be consumed by the continuous rotation that drives the casting roller 130 disposed on the source reservoir 110 and when the film source in the source reservoir 110 is gradually consumed, the lower portion of the source reservoir 110, that is, the film source 111 positioned at the corners is not applied to the carrier film 120 through the casting roller 130.

As described above, when the film source 111 is consumed in the source reservoir 110, the water level control plate 140 installed in the source reservoir 110 is driven to the upper portion so that the film source 111 in the source reservoir 110 always contacts the casting roller 130 at a predetermined level, thereby applying a predetermined amount to the carrier film 120 through the casting roller 130 when the film source 111 is consumed.

To this end, the water level control plate 140 moves up in the source reservoir 110 and the film source 111 always maintains a predetermined water level by moving the water level control plate 140 up. The water level control plate 140 may be configured to reciprocally move elastically by a plate driving unit 150 coupled with the bottom surface thereof.

The plate driving unit 150 coupled with the water level control plate 140 is configured to include a driving assembly 151 coupled with the lower surface of the water level control plate 140 and an elastic part 152 elastically moving the driving assembly 151. One side of the elastic part 152 may be coupled with the driving assembly 151 and the other side may be coupled with the bottom surface of the source reservoir 110.

The apparatus for supplying a source according to the exemplary embodiment of the present invention elastically moves the water level control plate 140 in the source reservoir 110 by the plate driving unit 150 to maintain a small amount of the film source 111 at a predetermined water level of the film source within the source reservoir 110 as shown in FIG. 3, when the amount of the liquid-phase film source 111 is consumed by consecutively applying the liquid-phase film source 111 in the source reservoir 110 on the carrier film 120 through the casting roller 130.

In this case, the plate driving unit 150 may be installed as a single member so that it is positioned at the central portion of the water level control plate 140, that is, the center of gravity of the water level control plate 140 and may be installed at both sides of the water control plate 140 as a plurality of members.

The plate driving unit 150 is installed as a plurality of members rather than being installed as a single member to drive the water level control plate 140 without being biased to one side. When the plate driving unit 150 is installed in plural, the amount of film source 111 that can be applied through the casting roller 130 by controlling the angle of the moving position at the both sides of the water level control plate 140 can be controlled.

Meanwhile, FIG. 4 is a diagram showing a configuration of the apparatus for supplying a source according to the present invention. In the apparatus for supplying a source according to the exemplary embodiment, when the water level control plate 140 moving in the source reservoir 110 moves and the water level of the film source 111 is controlled, the water level of the film source 111 is controlled by a sensor 160 and a controller 170.

The sensor 160 is a unit for sensing the amount of liquid-phase film source injected into the source reservoir 110. The sensor 160 senses whether the upper portion of the film source 111 is positioned at the water level displayed in the source reservoir 110 by the characteristics of the film source 111 that measures the mass of the film source 111 injected into the source reservoir 110 or maintains the predetermined water level.

That is, the sensor 160 is electrically connected to the source reservoir 110 to frequently check the amount of film source 111 and when the amount of film source 111 is gradually reduced, the consumed amount of film source 111 is transmitted to the controller 170 in real time.

The controller 170 moves the water level control plate 140 up and down based on the amount of film source 111 sensed in the sensor 160, thereby making it possible to constantly control the water level of the film source in the source reservoir 110.

Describing in more detail with reference to FIG. 4, when the film source 111 is continuously applied to the carrier film 120 through the casting roller 130, the consumed amount of film source 111 is checked in the sensor 160 and the consumed amount of film source 111 checked in real time is transmitted to the controller 170.

The controller 170 moves the water level control plate 140 up according to the consumed level of the film source 111. In this case, the elastic part 152 and the driving assembly 151 move up by controlling the plate driving unit 150 to move the water level control plate 140, thereby making it possible to constantly maintain the water level of the film source 111 as shown in FIG. 3.

It is preferable that the water level control plate 140 according to the control of the plate driving unit 150 gradually moves according to the gradual consumption amount of the film source 111. When the water level control plate 140 moves up to the upper end thereof by the plate driving unit 150, the film source is automatically injected into the source reservoir 110, so that the water level control plate 140 may back move to the lower side

In this case, by sensing the predetermined water level contracted with the information sensed in the sensor 160, that is, the mass of the film source 111 or the amount of injected film source 111, the water level control plate 140 may be returned to an original state by the control of the controller 170 as shown in FIG. 2.

In this configuration, a scheme of injecting the film source 111 into the source reservoir 110 while moving the water level control plate 140 to the lower side may be made manually by a worker, but preferably, a scheme of automatically supplying the source through a pumping unit 190 from a source supplying unit 180 formed in a general tank is used.

Describing in more detail, when the water level control plate 140 moves to the upper portion while the film source 111 is consumed in the source reservoir 110 as shown in FIG. 3, the sensor 160 senses this to transmit the information on the consumed amount of film source 111 to the controller 170, which transmits the supply information of the film source to the pumping unit 190 connected to the source supplying unit 190. In this case, the controller 170 descends the water level control plate 140 while controlling the supply of the pumping unit 190 by the controller 170, thereby additionally injecting the film source 111 while maintaining the film source 111 at the predetermined water level in the source reservoir 110 and when the injection of the film source 111 is completed and the water level control plate 140 moves to the bottom side as shown in FIG. 2, the supply of the film source 111 through the pumping unit 190 stops, thereby making it possible to continuously and circularly perform the supply of the film source 111.

During this process, the casting roller 130 positioned on the upper portion of the source reservoir 110 is continuously rotated to continuously apply the film source to the carrier film 120 delivered in one direction when contacting the casting roller 130, thereby making it possible to continuously perform the casting process without stopping the process for injecting the film source.

As described above, the apparatus for supplying a source according to the present invention automatically performs the water level of the film source injected into the source reservoir by sensing the consumed amount of film source in real time, thereby making it possible to improve the process efficiency by continuously performing the casting process.

Further, the apparatus for supplying a source according to the present invention makes the water level of the film source uniform to stably perform the casting process, thereby making it possible to make the amount of film source applied to the carrier film constant to minimize deviation in the thickness of the film and minimize the loss of the film source since the water level is controlled in real time.

Although the exemplary embodiments of the present invention have been disclosed for illustrative purposes, those skilled in the art will appreciate that various modifications, additions, and substitutions are possible, without departing from the scope and spirit of the invention as disclosed in the accompanying claims. Accordingly, such modifications, additions, and substitutions should also be understood to fall within the scope of the present invention.

What is claimed is:

1. An apparatus for supplying a source, comprising:
a source reservoir into which a liquid-phase film source is injected;
a carrier film that is horizontally delivered from one side of the source reservoir;
a casting roller that is rotated along the delivery direction of the carrier film and applies the liquid-phase film source injected into the source reservoir to the carrier film;
a water level control plate that is vertically driven in the source reservoir to control the liquid-phase film source level; and
a plate driving unit that moves the water level control plate up and down.

2. The apparatus for supplying a source according to claim 1, further comprising:
a sensor that senses the amount of liquid-phase film source injected into the source reservoir; and
a controller that moves the water level control plate with respect to the amount of film source sensed in the sensor to constantly control the film source water level in the source reservoir.

3. The apparatus for supplying a source according to claim 1, further comprising:
a source supplying unit that receives information on the consumed amount of film source from the sensor sensing the consumed amount of liquid-phase film source injected into the source reservoir to automatically supply the liquid-phase film source to the source reservoir; and
a pumping unit that supplies the liquid-phase film source into the source reservoir from the source supplying unit.

4. The apparatus for supplying a source according to claim 1, wherein the outer peripheral surface of the casting roller is provided with a step at equidistance.

5. The apparatus for supplying a source according to claim 2, wherein the sensor senses the mass of the film source injected into the source reservoir to transmit the information to the controller.

6. The apparatus for supplying a source according to claim 2, wherein the sensor senses the height where the upper end of the film source injected into the source reservoir is positioned in the source reservoir to transmit the information to the controller.

7. The apparatus for supplying a source according to claim 1, wherein the plate driving unit includes an elastic part attached to the bottom surface of the source reservoir and a driving assembly transferring a driving force to the water level control plate.

8. The apparatus for supplying a source according to claim 7, wherein the plate driving unit is installed at both side portions or a central portion of the water level control plate as a plurality of members or a single member.
